(19) United States
(12) Patent Application Publication
(10) Pub. No.: US 2005/0144982 A1
(43) Pub. Date: Jul. 7, 2005

(54) Glass molding tool

(75) Inventor: Jui-Fen Pai, Taichung (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Asia Optical Co., Inc., Taichung (TW)

(21) Appl. No.: 10/861,088

(22) Filed: Jun. 4, 2004

(30) Foreign Application Priority Data
Jan. 7, 2004 (TW) 093100345

(51) Int. Cl. C03B 40/00

(52) U.S. Cl. 65/169; 65/374.11

(57) ABSTRACT

A glass molding tool includes a molding core and a protective structure that is formed on the molding core and that includes a ceramic layer, a buffer layer formed on the ceramic layer and having a composition including a ceramic material and a metallic material, and a metallic layer formed on the buffer layer. The buffer layer has a ceramic concentration gradient that gradually decreases along a direction from the ceramic layer toward the metallic layer, and a metallic concentration gradient that gradually increases along the direction from the ceramic layer toward the metallic layer.

### CROSS-REFERENCE TO RELATED APPLICATION

This application claims priority of Taiwanese Patent Application No. 093100345, filed on Jan. 7, 2004.

### BACKGROUND OF THE INVENTION

1. Field of the Invention

This invention relates to a glass molding tool including a molding core and a protective structure, more particularly to a glass molding tool including a molding core and a multi-layer protective structure.

2. Description of the Related Art

Up to now, the problem encountered in the art of glass molding cores is that no suitable protective material for the glass molding core is available. The alloy film of noble metals plated on the glass molding core as the protective material is chemically inert, has difficulty in reacting with glass to be molded and active gases that exist in the molding atmosphere, and thus is an ideal material for the protective material. However, when the molding operation of glass is conducted continuously for a long period of time, the surface of the alloy film tends to be roughened due to grain growth. Hence, the molded glass thus made cannot satisfy the required optical quality. In addition, although ceramic films (such as chromium nitride and tantalum nitride, etc.) have good thermo-resistance and good adhesion to a tungsten carbide substrate of the glass molding core, they tend to react with glass to be molded and the active gases that exist in the molding atmosphere. Consequently, the surface of the ceramic films tends to be discolored and adhere to the glass to be molded. As shown in FIG. 1, Japanese Patent Publication no. 05-294642 describes a multi-layer mold 1 for molding glass. The multi-layer mold 1 includes a substrate 11 made from tungsten carbide, and a multi-layer film 12 formed on a surface of the substrate 11. The multi-layer film 12 includes a plurality of ceramic layers that are made from titanium nitride, and a plurality of metallic layers that are made from platinum iridium alloy. The ceramic layers and the metallic layers are alternately laminated. The layer that is directly connected to the substrate 11 is required to be a ceramic layer.

Although the grain growth of the metallic layers, the discoloration of the ceramic layers, and the adhesion of the ceramic layers to the glass can be avoided by using the mold 1 as described in the aforesaid Japanese publication, the adhesivity between each ceramic layer and an adjacent metallic layer is poor as a result of the great difference in surface properties between the metallic layers and the ceramic layers. Therefore, how to improve the adhesivity between the ceramic layers and the metallic layers is a pressing need in the art of glass molding cores.

### SUMMARY OF THE INVENTION

Therefore, the object of the present invention is to provide a glass molding tool that can overcome the aforesaid drawbacks of the prior art.

According to the present invention, a glass molding tool includes a molding core and a protective structure that is formed on the molding core and that includes a ceramic layer formed on the molding core, a buffer layer that is formed on the ceramic layer and that has a composition including a ceramic material and a metallic material, and a metallic layer formed on the buffer layer. The buffer layer has a ceramic concentration gradient that gradually decreases along a direction from the ceramic layer toward the metallic layer, and has a metallic concentration gradient that gradually increases along the direction from the ceramic layer toward the metallic layer.

### BRIEF DESCRIPTION OF THE DRAWINGS

Other features and advantages of the present invention will become apparent in the following detailed description of the preferred embodiment of the invention, with reference to the accompanying drawings. In the drawings:

FIG. 1 is a schematic side view to illustrate a conventional molding core for molding glass;

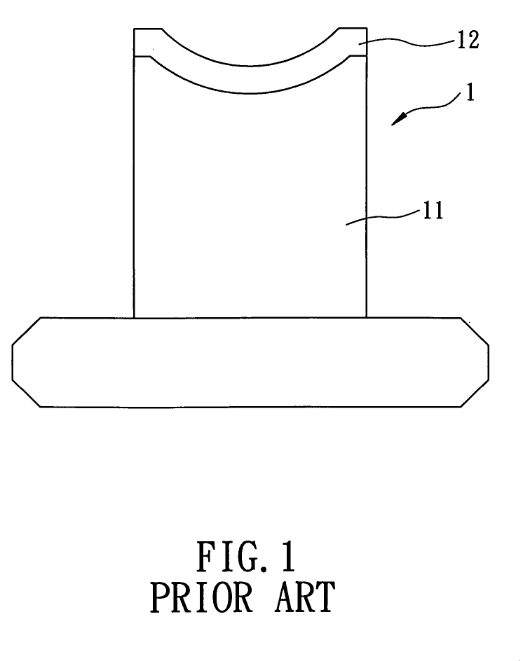

FIG. 2 is a schematic fragmentary side view to illustrate the preferred embodiment of a glass molding tool according to this invention;

FIG. 3 is a partially enlarged schematic view of the glass molding tool shown in FIG. 2 to illustrate a second protective structure included in the glass molding tool;

FIG. 4 is a plot to illustrate changes in the ceramic concentration gradient and the metallic concentration gradient of a first buffer layer of the glass molding tool shown in FIG. 2 during a co-sputtering operation; and

FIG. 5 is a plot to illustrate changes in the ceramic concentration gradient and the metallic concentration gradient of a second buffer layer of the glass molding tool as shown in FIG. 2 during a co-sputtering operation.

### DETAILED DESCRIPTION OF THE PREFERRED EMBODIMENT

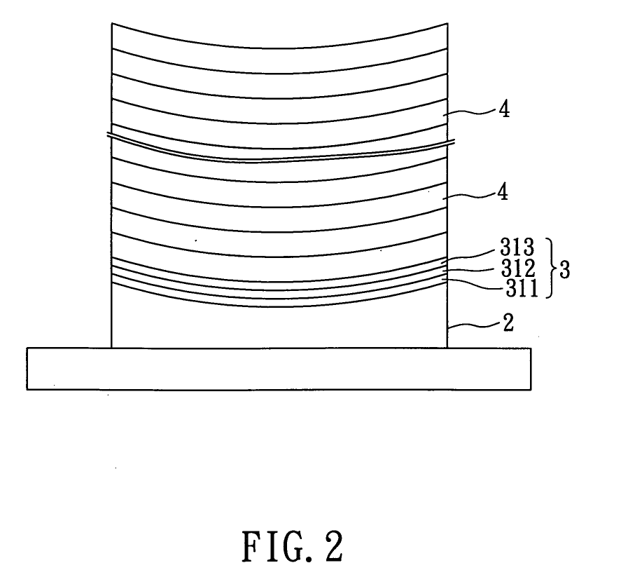

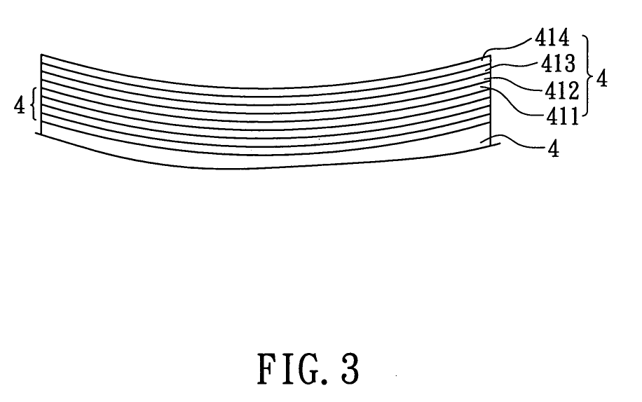

Referring to FIGS. 2 and 3, the preferred embodiment of a glass molding tool according to this invention is shown to include a molding core 2 that is made from tungsten carbide and a first protective structure 3 that is formed on the molding core 2 and that includes a first ceramic layer 311 formed on the molding core 2, a first buffer layer 312 that is formed on the first ceramic layer 311 and that has a composition including a first ceramic material and a first metallic material, and a first metallic layer 313 formed on the first buffer layer 312. The first buffer layer 312 has a ceramic concentration gradient that gradually decreases along a direction from the first ceramic layer 311 toward the first metallic layer 313, and a metallic concentration gradient that gradually increases along the direction from the first ceramic layer 311 toward the first metallic layer 313.

Preferably, the glass molding tool of this embodiment further includes a second protective structure 4 that includes a second buffer layer 411 formed on the first metallic layer 313 of the first protective structure 3 and having a composition including a second ceramic material and a second metallic material, a second ceramic layer 412 formed on the second buffer layer 411, a third buffer layer 413 formed on the second ceramic layer 412 and having a composition including a third ceramic material and a third metallic material, and a second metallic layer 414 formed on the third buffer layer 413. The second buffer layer 411 has a ceramic concentration gradient that gradually increases along a direction from the first metallic layer 313 of the first protective structure 3 toward the second ceramic layer 412 of the second protective structure 4, and a metallic concentration gradient that gradually decreases along the direction from the first metallic layer 313 of the first protective structure 3 toward the second ceramic layer 412 of the second protective structure 4. The third buffer layer 413 has a ceramic concentration gradient that gradually decreases along a direction from the second ceramic layer 412 toward the second metallic layer 414, and a metallic concentration gradient that gradually increases along the direction from the second ceramic layer 412 toward the second metallic layer 414.

In this embodiment, each of the first, second and third ceramic materials and the first and second ceramic layers 311, 412 is made from a compound selected from the group consisting of nitride, carbide and boride. Preferably, the nitride is selected from the group consisting of titanium chromium nitride (TiCrN), titanium aluminum nitride (TiAlN), chromium nitride (CrN), tantalum nitride (TaN), titanium nitride (TiN), and aluminum nitride (AlN). Preferably, the carbide is selected from the group consisting of titanium carbide (TiC), chromium carbide (Cr₃C₂), zirconium carbide (ZrC), niobium carbide (NbC), and tantalum carbide (TaC).

In addition, in this embodiment, each of the first, second and third metallic materials and the first and second metallic layers 313, 414 is made from a noble metal selected from the group consisting of iridium (Ir), rhenium (Re), ruthenium (Ru), rhodium (Rh), platinum (Pt), osmium (Os), and alloys thereof. Preferably, each of the first, second and third metallic materials and the first and second metallic layers 313, 414 is made from an alloy of iridium (Ir) and rhenium (Re). Alternatively, each of the first, second and third metallic material and the first and second metallic layers 313, 414 is made from an alloy of iridium (Ir) and ruthenium (Ru).

In another aspect, each of the first metallic layer 313 of the first protective structure 3 and the second metallic layer 414 of the second protective structure 4 may contain an additional element that has a high melting point and that is selected from the group consisting of tantalum (Ta), carbon (C), titanium (Ti), chromium (Cr), tungsten (W), and manganese (Mn). Preferably, the element is tantalum (Ta). The grain growth at the grain boundary of each of the first and second metallic layers 313, 414 can be inhibited by including a high melting point element in these metallic layers 313, 414.

The glass molding tool of this invention may include a plurality of the second protective structures 4, as best shown in FIG. 2. Preferably, the glass molding tool of this invention includes six to twenty layers of the second protective structure 4. Each of the first and second ceramic layers 311, 412, the first, second and third buffer layers 312, 411, 413, and the first and second metallic layers 313, 414 has a thickness ranging from 10 nm to 30 nm.

The structural feature of the glass molding tool and the ceramic and metallic concentration gradients will be explained in greater detail with reference to the following examples:

### EXAMPLE 1

In this Example, the molding core 2 is made from WC, the first ceramic layer 311 is a TiCrN layer, and the first metallic layer 313 is an Ir—Re layer. The first buffer layer 312 has a TiCrN concentration gradient that gradually decreases along the direction from the first ceramic layer 311 toward the first metallic layer 313, and an Ir—Re concentration gradient that gradually increases along the direction from the first ceramic layer 311 toward the first metallic layer 313.

The second ceramic layer 412 is a TiCrN layer. The second metallic layer 414 is an Ir—Re layer. The second buffer layer 411 has a TiCrN concentration gradient that gradually increases along the direction from the first metallic layer 313 of the first protective structure 3 toward the second ceramic layer 412 of the second protective structure 4, and an Ir—Re concentration gradient that gradually decreases along the direction from the first metallic layer 313 of the first protective structure 3 toward the second ceramic layer 412 of the second protective structure 4. The third buffer layer 413 has a TiCrN concentration gradient that gradually decreases along the direction from the second ceramic layer 412 toward the second metallic layer 414, and a metallic concentration gradient that gradually increases along the direction from the second ceramic layer 412 toward the second metallic layer 414.

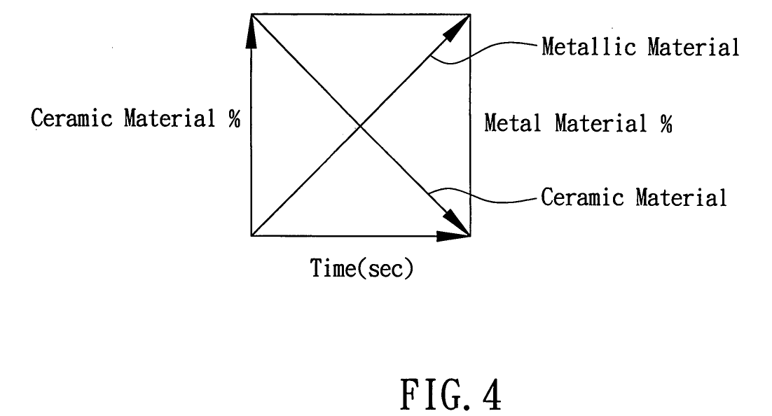

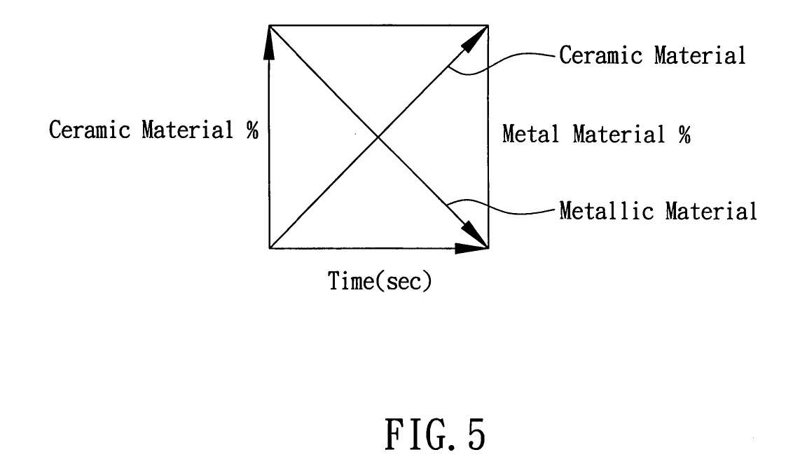

Each of the first, second and third buffer layers 312, 411, 413 is prepared by co-sputtering techniques. During the sputtering operation, the powers for a ceramic target and a metal target disposed on a cathode are adjusted so as to form the ceramic concentration gradient and the metallic concentration gradient in the first and third buffer layers 312, 413 (as shown in FIG. 4) and the second buffer layer 411 (as shown in FIG. 5). The adhesion of the ceramic layers 311, 412 to the respective metallic layers 313, 414 can be significantly improved through the first, second and third buffer layers 312, 411, 413.

In this example, the thickness of each of the first and second ceramic layers 311, 412, the first, second and third buffer layers 312, 411, 413, and the first and second metallic layers 313, 414 ranges from about 10 to 30 nm. The total thickness of the first and second protective structures 3, 4 is preferably less than 1 μm. As such, the grain size thus obtained in the interior of the first and second metallic layers 313, 414 can be as small as to prevent nucleation from taking place, thereby inhibiting the grain growth therein and avoiding the roughening of the metallic surfaces of the Ir—Re layers 313, 414.

### EXAMPLE 2

The glass molding tool prepared in this Example is similar to that of Example 1, except that the first and second ceramic layers 311, 412 and the first, second and third ceramic materials are made from TiC, and that the first and second metallic layers 313, 414 and the first, second and third metallic materials are made from Ir—Ru.

### EXAMPLE 3

The glass molding tool prepared in this Example is similar to that of Example 1, except that the first and second ceramic layers 311, 412 and the first, second and third ceramic materials are made from TiC, and that the first and second metallic layers 313, 414 and the first, second and third metallic materials are made from Ir—Re—Ta.

As described above, the grain growth at the grain boundary of each of the first and second metallic layers 313, 414 can be inhibited by including an additional high melting point element, Ta, in the first and second metallic layers 313, 414.

In view of the foregoing, the glass molding tool according to this invention has specific functions and properties as follows:

(1) The adhesion of the first and second ceramic layers 311, 412 to the respective first and second metallic layers 313, 414 can be considerably improved through the buffer layers 312, 411, 413.

(2) Since the thickness of each of the first and second ceramic layers 311, 412, the first, second and third buffer layers 312, 411, 413, and the first and second metallic layers 313, 414 is controlled within a range of 10 to 30 nm, the grain size in the interior of the first and second metallic layers 313, 414 is smaller than that required for undesirable nucleation so as to inhibit the grain growth therein and so as to avoid the roughening of the surfaces of the first and second metallic layers 313, 414.

(3) The ceramic layers 311, 412 provide sufficient hardness to resist wearing and thermal shock, thereby prolonging the service life of the glass molding tool.

While the present invention has been described in connection with what is considered the most practical and preferred embodiment, it is understood that this invention is not limited to the disclosed embodiments but is intended to cover various arrangements included within the spirit and scope of the broadest interpretations and equivalent arrangements.

1. A glass molding tool, comprising:
a molding core; and
a first protective structure that is formed on said molding core and that includes
a first ceramic layer formed on said molding core;
a first buffer layer that is formed on said first ceramic layer and that has a composition including a first ceramic material and a first metallic material; and
a first metallic layer formed on said first buffer layer;
wherein said first buffer layer has a ceramic concentration gradient that gradually decreases along a direction from said first ceramic layer toward said first metallic layer, and a metallic concentration gradient that gradually increases along the direction from said first ceramic layer toward said first metallic layer.

2. The glass molding tool according to claim 1, further comprising a second protective structures that includes
a second buffer layer formed on said first metallic layer of said first protective structure and having a composition including a second ceramic material and a second metallic material;
a second ceramic layer formed on said second buffer layer;
a third buffer layer formed on said second ceramic layer and having a composition including a third ceramic material and a third metallic material; and
a second metallic layer formed on said third buffer layer;
wherein said second buffer layer has a ceramic concentration gradient that gradually increases along a direction from said first metallic layer of said first protective structure toward said second ceramic layer of said second protective structure, and a metallic concentration gradient that gradually decreases along the direction from said first metallic layer of said first protective structure toward said second ceramic layer of said second protective structure; and
wherein said third buffer layer has a ceramic concentration gradient that gradually decreases along a direction from said second ceramic layer toward said second metallic layer, and a metallic concentration gradient that gradually increases along the direction from said second ceramic layer toward said second metallic layer.

3. The glass molding tool according to claim 1, wherein each of said first ceramic layer and said first ceramic material is made from a compound selected from the group consisting of nitride, carbide and boride.

4. The glass molding tool according to claim 3, wherein the nitride is selected from the group consisting of titanium chromium nitride (TiCrN), titanium aluminum nitride (TiAlN), chromium nitride (CrN), tantalum nitride (TaN), titanium nitride (TiN), and aluminum nitride (AlN).

5. The glass molding tool according to claim 3, wherein the carbide is selected from the group consisting of titanium carbide (TiC), chromium carbide (Cr₃C₂), zirconium carbide (ZrC), niobium carbide (NbC), and tantalum carbide (TaC).

6. The glass molding tool according to claim 1, wherein each of said first metallic material and said first metallic layer are made from a noble metal selected from the group consisting of iridium (Ir), rhenium (Re), ruthenium (Ru), rhodium (Rh), platinum (Pt), osmium (Os), and alloys thereof.

7. The glass molding tool according to claim 6, wherein each of said first metallic material and said first metallic layer is made from an alloy of iridium (Ir) and rhenium (Re).

8. The glass molding tool according to claim 6, wherein each of said first metallic material and said first metallic layer is made from an alloy of iridium (Ir) and ruthenium (Ru).

9. The glass molding tool according to claim 1, wherein said first metallic layer further includes an element selected from the group consisting of tantalum (Ta), carbon (C), titanium (Ti), chromium (Cr), tungsten (W), and manganese (Mn).

10. The glass molding tool according to claim 9, wherein said element is tantalum (Ta).

11. The glass molding tool according to claim 2, wherein each of said second ceramic material, said second ceramic layer and said third ceramic material is made from a compound selected from the group consisting of nitride, carbide and boride.

12. The glass molding tool according to claim 11, wherein the nitride is selected from the group consisting of titanium chromium nitride (TiCrN), titanium aluminum nitride (TiAlN), chromium nitride (CrN), tantalum nitride (TaN), titanium nitride (TiN), and aluminum nitride (AlN).

13. The glass molding tool according to claim 11, wherein the carbide is selected from the group consisting of titanium carbide (TiC), chromium carbide (Cr₃C₂), zirconium carbide (ZrC), niobium carbide (NbC), and tantalum carbide (TaC).

14. The glass molding tool according to claim 2, wherein each of said second metallic material, said second metallic layer and said third metallic material is made from a noble metal selected from the group consisting of iridium (Ir), rhenium (Re), ruthenium (Ru), rhodium (Rh), platinum (Pt), osmium (Os), and alloys thereof.

15. The glass molding tool according to claim 14, wherein each of said second metallic material, said second metallic layer and said third metallic material is made from an alloy of iridium (Ir) and rhenium (Rh).

16. The glass molding tool according to claim 14, wherein each of said second metallic material, said second metallic layer and said third metallic material is made from an alloy of iridium (Ir) and ruthenium (Ru).

17. The glass molding tool according to claim 2, wherein said second metallic layer further includes an element selected from the group consisting of tantalum (Ta), carbon (C), titanium (Ti), chromium (Cr), tungsten (W), and manganese (Mn).

18. The glass molding tool according to claim 17, wherein said element is tantalum (Ta).

19. The glass molding tool according to claim 2, wherein each of said first and second ceramic layers, said first, second and third buffer layers and said first and second metallic layers has a thickness ranging from 10 nm to 30 nm.

20. The glass molding tool according to claim 1, further comprising a plurality of stacked second protective structures formed on said first protective structure, each of which includes
a second buffer layer having a composition including a second ceramic material and a second metallic material;
a second ceramic layer formed on said second buffer layer;
a third buffer layer formed on said second ceramic layer and having a composition including a third ceramic material and a third metallic material; and
a second metallic layer formed on said third buffer layer;
wherein said second buffer layer has a ceramic concentration gradient that gradually increases along a direction from said first metallic layer of said first protective structure toward said second ceramic layer of said second protective structure, and a metallic concentration gradient that gradually decreases along the direction from said first metallic layer of said first protective structure toward said second ceramic layer of said second protective structure;
wherein said third buffer layer has a ceramic concentration gradient that gradually decreases along a direction from said second ceramic layer toward said second metallic layer, and a metallic concentration gradient that gradually increases along the direction from said second ceramic layer toward said second metallic layer; and
wherein said first protective structure and said plurality of stacked second protective structures have a total thickness less than 1 μm.
